(19) United States
(12) Patent Application Publication
(10) Pub. No.: US 2018/0195977 A1
(43) Pub. Date: Jul. 12, 2018

(54) INSPECTION DEVICES AND METHODS FOR DETECTING A FIREARM IN A LUGGAGE

(71) Applicants: Nuctech Company Limited, Beijing (CN); Tsinghua University, Beijing (CN)

(72) Inventors: Qili Wang, Beijing (CN); Shiyu Dai, Beijing (CN); Jianping Gu, Beijing (CN); Yaohong Liu, Beijing (CN); Ziran Zhao, Beijing (CN)

(21) Appl. No.: 15/868,359

(22) Filed: Jan. 11, 2018

(30) Foreign Application Priority Data
Jan. 12, 2017 (CN) 201710021887.6

(51) Int. Cl. G01N 23/04; G06T 7/00; G06K 9/62; G06T 5/50; G06T 7/73; G06K 9/20; G06N 3/04; G06N 3/08

(52) U.S. Cl. CPC G01N 23/04; G06T 7/001; G06K 9/6267; G06T 5/50; G06T 7/74; G06K 9/6256; G06T 2207/20221; G06N 3/04; G06N 3/0454; G06N 3/08; G06T 2207/30112; G06T 2207/30232; G06T 2207/10116; G06K 9/2054

(57) ABSTRACT

An inspection device and a method for detecting a firearm in a luggage are disclosed. The method comprises: performing X-ray inspection on the luggage to obtain a transmission image; determining a plurality of candidate regions in the transmission image using a trained firearm detection neural network; and classifying the plurality of candidate regions using the detection neural network to determine whether there is a firearm included in the transmission image. With the above solutions, it is possible to determine more accurately whether there is a firearm included in a luggage. In other embodiments, after a firearm is detected using the above method, a label is marked in the image to prompt an image judger.

### CROSS-REFERENCE TO RELATED APPLICATION

The present application claims priority to Chinese Patent Application No. 201710021887.6, filed on Jan. 12, 2017, entitled “Inspection Devices and Methods for Detecting a Firearm in a Luggage”, which is incorporated herein by reference in its entirety.

### TECHNICAL FIELD

The present disclosure relates to radiation inspection technologies, and more particularly, to an inspection device and a method for detecting a firearm in a luggage.

### BACKGROUND

Firearms are weapons having direct lethality and great destructive power, and if firearms are illegally carried, it may cause great potential dangers and social hidden dangers, and have a direct impact on social stability and people's lives and property. There is a large daily passenger flow in civil aviation, subway and rail transit systems, and the current manual detection is slow and relies heavily on the staff. Therefore, it is also the focus of attention today to improve a degree of automation and a detection speed of a system for detecting a firearm.

There is currently no effective means of detecting a firearm. According to the research, firearms are mainly transported through a luggage. Radiation imaging achieves the purpose of non-invasive inspection by imaging cargos and a luggage. This technology has been widely used in places such as airports, stations, express sites etc., and is the most important means in the field of security inspection for prohibited articles. In the process of inspecting using a small article machine, although an image of the interior of a luggage has been obtained, the effect of manual judgment is unsatisfied since there is a wide variety of articles, image judgers have various experience levels and it is a low probability that dangerous articles such as firearms exist.

### SUMMARY

In view of one or more of the problems in the related art, an inspection device and a method for detecting a firearm in a luggage are proposed.

According to an aspect of the present disclosure, there is proposed a method for detecting a firearm in a luggage, comprising steps of: performing X-ray inspection on the luggage to obtain a transmission image; determining a plurality of candidate regions in the transmission image using a trained firearm detection neural network; and classifying the plurality of candidate regions using the detection neural network to determine whether there is a firearm included in the transmission image.

According to an embodiment of the present disclosure, the method further comprises steps of: calculating a confidence level of including a firearm in each candidate region, and determining that there is a firearm included in a candidate region in a case that a confidence level for the candidate region is greater than a specific threshold.

According to an embodiment of the present disclosure, the method further comprises steps of: in a case that the same firearm is included in a plurality of candidate regions, marking and fusing images of the firearm in various candidate regions to obtain a position of the firearm.

According to an embodiment of the present disclosure, the firearm detection neural network is trained by the following operations: creating sample transmission images of firearms; fusing a Region Proposal Network (RPN) and a conventional layer of a Convolutional Neural Network (CNN) to obtain an initial detection network; and training the initial detection network using the sample transmission images to obtain the firearm detection neural network.

According to an embodiment of the present disclosure, the step of training the initial detection network comprises: adjusting the initial detection network using a plurality of sample candidate regions determined from the sample transmission images in a case of not sharing data of the convolutional layer between the RPN and the CNN; training the RPN in a case of sharing the data of the convolutional layer between the RPN and the CNN; and adjusting the initial detection network to converge in a case of keeping sharing the data of the convolutional layer between the RPN and the CNN unchanged to obtain the firearm detection neural network.

According to an embodiment of the present disclosure, the step of training the initial detection network further comprises: deleting a sample candidate region in the plurality of sample candidate regions which has an overlapped area less than a threshold with a rectangular block which is manually marked for a firearm.

According to another aspect of the present disclosure, there is proposed an inspection device, comprising: an X-ray inspection system configured to perform X-ray inspection on a luggage to obtain a transmission image; a memory having the transmission image stored thereon; and a processor configured to: determine a plurality of candidate regions in the transmission image using a trained firearm detection neural network; and classify the plurality of candidate regions using the firearm detection neural network to determine whether there is a firearm included in the transmission image.

According to an embodiment of the present disclosure, the processor is configured to calculate a confidence level of including a firearm in each candidate region, and determine that there is a firearm included in a candidate region in a case that a confidence level for the candidate region is greater than a specific threshold.

According to an embodiment of the present disclosure, the processor is configured to mark and fuse images of the firearm in various candidate regions to obtain a position of the firearm in a case that the same firearm is included in a plurality of candidate regions.

According to an embodiment of the present disclosure, the memory has sample transmission images of firearms stored thereon, and the processor is configured to train the firearm detection neural network by the following operations: fusing a Region Proposal Network (RPN) and a conventional layer of a Convolutional Neural Network (CNN) to obtain an initial detection network; and training the initial detection network using the sample transmission images to obtain the firearm detection neural network.

With the above solutions, it is possible to determine more accurately whether there is a firearm included in a luggage. In other embodiments, after a firearm is detected using the above method, a label is marked in the image to prompt an image judger, thereby reducing the workload of manual image judgment.

### BRIEF DESCRIPTION OF THE DRAWINGS

For a better understanding of the present disclosure, the present disclosure will be described in detail according to the following accompanying drawings:

FIG. 1 is a structural diagram of an inspection device according to an embodiment of the present disclosure;

FIG. 2 is a diagram illustrating a structure of a computing device included in the inspection device illustrated in FIG. 1;

FIG. 3 is a diagram illustrating a process of creating a database for training according to an embodiment of the present disclosure;

FIG. 4 is a diagram illustrating a process of creating a firearm detection network model;

FIG. 5 is a schematic flowchart specifically illustrating creating a firearm detection network model according to an embodiment of the present disclosure;

FIG. 6 illustrates a schematic flowchart of a process of detecting firearms according to an embodiment of the present disclosure; and

FIG. 7 illustrates a diagram of detecting a firearm in a luggage according to an embodiment of the present disclosure.

### DETAILED DESCRIPTION

The specific embodiments of the present disclosure will be described in detail below. It should be noted that the embodiments herein are used for illustration only, without limiting the present disclosure. In the description below, a number of specific details are explained to provide better understanding of the present disclosure. However, it is apparent to those skilled in the art that the present disclosure can be implemented without these specific details. In other instances, well known structures, materials or methods are not described specifically so as not to obscure the present disclosure.

Throughout the specification, the reference to “one embodiment,” “an embodiment,” “one example” or “an example” means that the specific features, structures or properties described in conjunction with the embodiment or example are included in at least one embodiment of the present disclosure. Therefore, the phrases “in one embodiment,” “in an embodiment,” “in one example” or “in an example” occurred in various positions throughout the specification may not necessarily refer to the same embodiment or example. Furthermore, specific features, structures or properties may be combined into one or more embodiments or examples in any appropriate combination and/or sub-combination. Moreover, it should be understood by those skilled in the art that the term “and/or” used herein means any and all combinations of one or more listed items.

In view of the problems in the related art, the embodiments of the present disclosure propose a method for detecting a firearm in a luggage. A plurality of candidate regions in a transmission image are determined using a trained firearm detection neural network, and then the plurality of candidate regions are classified using the firearm detection neural network to determine whether there is a firearm included in the transmission image. In this way, it is more accurately detected whether there is a firearm included in a luggage.

The automatic firearm detection technology according to the embodiments of the present disclosure includes three steps of 1) creating a firearm detection database, 2) automatically creating an detection model, and 3) automatically detecting a firearm. Specifically, creating a firearm detection database comprises three steps of image acquisition, image preprocessing and region of interest extraction. Automatically detecting a firearm primarily comprises three steps of image preprocessing, judgment and marking a suspicious region.

Before a firearm detection model is created, a firearms detection database is created, which includes three steps of image acquisition, image preprocessing and region of interest extraction. Image acquisition includes, for example, collecting a considerable number of images of firearms from a small article machine, so that an image database includes images of different numbers of firearms which are placed in various forms. The image preprocessing specifically involves, for example, a normalization process. Different scanning devices may obtain different images due to different energy/doses of ray sources and different sizes of detectors. In order to reduce this difference, the image may be normalized. In addition, the region of interest extraction involves manually marking positions of firearms in units of firearms in the scanned grayscale image and giving coordinates (x,y,w,h) of the firearms, where x and y represent coordinates of a lower left apex of a circumscribed rectangle of a firearm, W represents a width of the circumscribed rectangle, and h represents a height of the circumscribed rectangle.

A detection model is automatically created using the deep learning theory. For example, in the present application, a firearm is primarily detected using the deep learning theory. There are many types of neural networks in the field of computer vision, but the Convolutional Neural Network (CNN) is a deep learning model which is most widely used. Candidate region extraction and CNN classification are performed using a CNN as an example in the embodiments of the present disclosure. The candidate region extraction uses a Region Proposal Network (RPN) to realize an end-to-end network for detecting a firearm.

A firearm detection process involves directly generating candidate regions using a trained CNN and classifying the candidate regions to determine whether there is a firearm in the candidate regions. In addition, a specific position of the firearm in the candidate regions is regressed to determine coordinates of the firearm, and a detection result marked in a rectangular block may be given.

FIG. 1 illustrates a structural diagram of an inspection device according to an embodiment of the present disclosure. As shown in FIG. 1, an inspection device 100 according to an embodiment of the present disclosure comprises an X-ray source 110, a detector 130, a data collection apparatus 150, a controller 140, and a computing device 160, and performs security inspection on an inspected object 120 such as a container truck etc., for example, judges whether there is a firearm included therein. Although the detector 130 and the data collection apparatus 150 are separately described in this embodiment, it should be understood by those skilled in the art that they may also be integrated together as an X-ray detection and data collection device.

According to some embodiments, the X-ray source 110 may be an isotope, or may also be an X-ray machine, an accelerator, etc. The X-ray source 110 may be a single-energy ray source or a dual-energy ray source. In this way, transmission scanning is performed on the inspected object 120 through the X-ray source 110, the detector 150, the controller 140, and the computing device 160 to obtain detection data. For example, in a process that the inspected object 120 moves, an operator controls the controller 140 to transmit an instruction through a man-machine interface of the computing device 160 to instruct the X-ray source 110 to emit rays, which are transmitted through the inspected object 120 and are then received by the detector 130 and the data collection device 150. Further, data is processed by the computing device 160 to obtain a transmission image and store the transmission image in a memory, then a plurality of candidate regions in the transmission image are determined using a trained firearm detection neural network, and the plurality of candidate regions are classified using the firearm detection neural network to determine whether there is a firearm included in the transmission image.

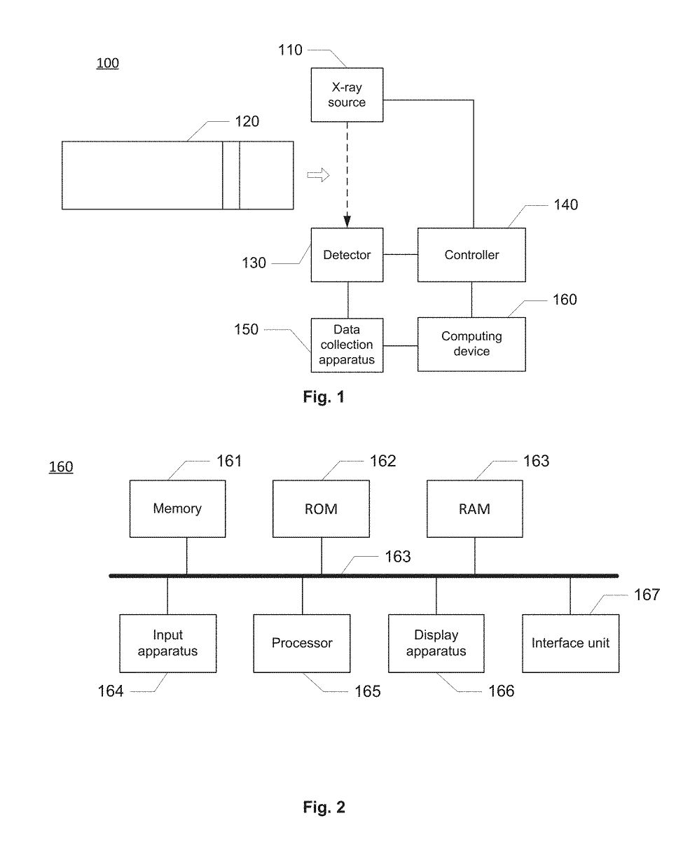

FIG. 2 illustrates a structural diagram of the computing device illustrated in FIG. 1. As shown in FIG. 2, a signal detected by the detector 130 is collected by a data collector, and data is stored in a memory 161 through an interface unit 167 and a bus 163. A Read Only Memory (ROM) 162 stores configuration information and programs of a computer data processor. A Random Access Memory (RAM) 163 is configured to temporarily store various data when a processor 165 is in operation. In addition, computer programs for performing data processing, such as an image processing program, a firearm recognition convolutional network program etc., are also stored in the memory 161. The internal bus 163 connects the memory 161, the ROM 162, the RAM 163, an input apparatus 164, the processor 165, a display apparatus 166, and the interface unit 167 described above.

After a user inputs an operation command through the input apparatus 164 such as a keyboard and a mouse etc., instruction codes of a computer program instruct the processor 165 to perform a predetermined data processing algorithm. After a result of the data processing is acquired, the result is displayed on the display apparatus 166 such as a Liquid Crystal Display (LCD) display etc. or is directly output in a form of hard copy such as printing etc. In addition, the processor 165 in the computer may be configured to execute a software program to calculate a confidence level of including a firearm in each candidate region, and determine that there is a firearm included in the candidate region if the confidence level is greater than a specific threshold. In addition, the processor 165 may be configured to execute a software program to mark an image of a firearm in each candidate region in a case that the same firearm is included in a plurality of candidate regions, and fuse images of the firearm in various candidate regions, to obtain a position of the firearm.

According to an embodiment of the present disclosure, a method for automatically detecting a firearm according to the present disclosure is mainly based on the deep learning theory, and performs training using a CNN network to obtain a detection model. For example, a convolutional neural network is used to automatically detect a firearm region in a radiation image. Before the convolutional network is trained, a firearm detection database needs to be created to train the convolutional network.

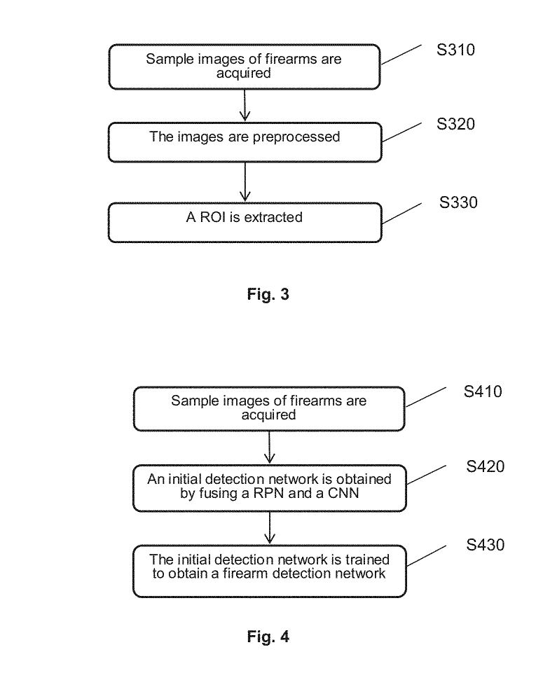

FIG. 3 is a diagram illustrating a process of creating a database for training according to an embodiment of the present disclosure. As shown in FIG. 3, a firearm detection database is primarily created through three steps which are image collection, image pre-processing, and Region Of Interest (ROI) extraction.

In step S310, sample images are acquired. For example, a considerable number of images of firearms from a small article machine are collected, so that an image database includes images of different numbers of firearms which are placed in various forms to obtain a firearm image library { }. The diversity of the samples is enriched, so that a firearm detection algorithm according to the present disclosure has a generalization capability.

In step S320, the images are preprocessed. For example, in order to be applicable to scanning devices of various small article machines, the images may be normalized while acquiring the images. Specifically, assuming that an original two-dimensional image signal is X, a normalized image X may be obtained by scaling a resolution of X to 5 mm/pixel according to physical parameters of a scanning device and performing grayscale stretching on X.

In step S330, a ROI is extracted. For example, an air part in X̅ is detected and is excluded from a detection process, which on the one hand speeds up the operation, and on the other hand avoids a false positive in the air. For example, statistics is performed on a histogram of X̅, a brightest peak a is calculated in the histogram, a normalized air distribution (a, σₐ) with the brightest peak a as a center is fitted, and then a threshold is set as tₐ=a−3*σₐ. Pixels in X̅ which are greater than tₐ are considered to be air, and are not subjected to detection and calculation. In this way, in the scanned grayscale image, positions of firearms are manually marked in units of firearms and coordinates (x,y,w,h) of the firearms are given, where x and y represent coordinates of a lower left apex of a circumscribed rectangle of a firearm, w represents a width of the circumscribed rectangle, and h represents a height of the circumscribed rectangle.

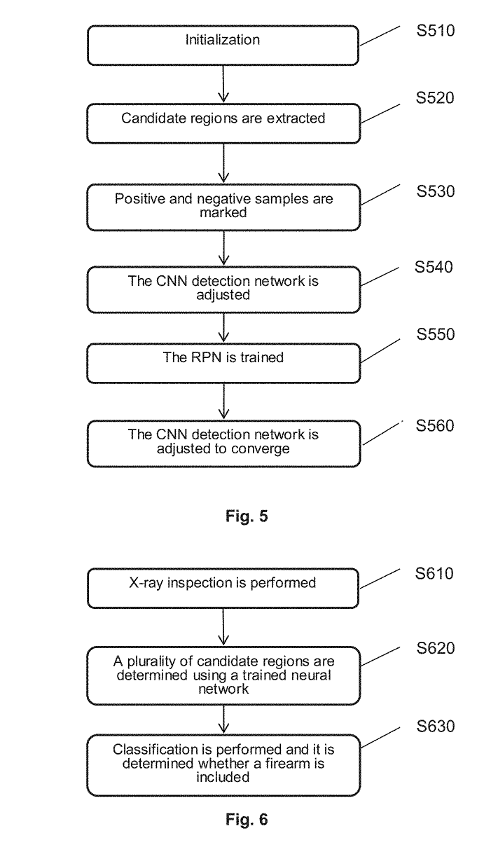

FIG. 4 is a diagram illustrating a process of creating a firearm detection network model according to an embodiment of the present disclosure. As shown in FIG. 4, in the embodiment of the present disclosure, a region proposal method is adopted, and candidate region extraction is combined with CNN classification by using a RPN network to create an end-to-end firearm detection network. In step S410, sample transmission images of firearms are acquired. For example, the sample transmission images are obtained from the firearm sample image database created above. In step S420, an initial detection network is obtained by fusing the RPN and a convolutional layer of a CNN, and then in step S430, the initial detection network is trained by using the sample transmission images to obtain a firearm detection neural network.

According to an embodiment of the present disclosure, a RPN module and a CNN detection module are used in the present algorithm. There are two training methods, one of which is an alternative training method, and the other of which is a fusion training method. The fusion training method is different from the alternative training method in that in the process of reverse regression, a layer shared by the two networks combines a loss of the RPN network with a loss of the CNN detection network together. FIG. 5 illustrates an example of the alternate training method. A specific training process of the alternate training method is as follows.

In step S510, initialization is performed. Firstly, an input image is scaled to a size of less than 600 pixels in the short side, and weights in the RPN network and the CNN detection network are initialized by a pre-trained model, wherein initial biases of a visible layer and a hidden layer are a and b, an initial weight matrix is W, and increments of the biases and the weight matrix are Δa, Δb and ΔW. The advantage of using the pre-trained model to initialize the network is that the model is nearly optimal to some extent, and saves time and resources over random initialization.

In step S520, candidate regions are extracted. On a feature map extracted on a last layer of the CNN network, n*n sliding windows are used to generate full connection features with a length in m dimensions, which are combined with a region of interest in each sliding window, to generate candidate regions X={x̅₁̅,x̅₂̅,x̅₃̅, . . . , x̅ₖ̅} using different scales and image aspect ratios, where k is a number of the extracted candidate regions. At the same time, two branches of full connection layers are generated on this layer of features, which are a rectangular block classification layer and a rectangular block regression layer, and there are 2*k candidate regions and 4*k candidate regions on these two different layers respectively.

In step S530, positive and negative samples are marked. After the candidate regions are extracted, positive and negative samples are marked for the candidate regions using a marking rule as follows. When a portion of a rectangular block of a candidate region which is overlapped with a real value is greater than 0.7, the candidate region is marked as a positive sample, and when a portion of a rectangular block of a candidate region which is overlapped with the real value is less than 0.3, the candidate region is marked as a negative sample. Remaining candidate regions are discarded, and are not used for training.

In step S540, the obtained candidate regions are combined with the obtained CNN detection network to fine-tune the detection network. In this step, both networks do not share data of the convolutional layer.

In step 550, a trained network is used to initialize the RPN and train the RPN network. In this step, the data of the convolutional layer is fixed, and only a part of the network layer which belongs to the RPN is fine-tuned. In this step, both networks share the convolutional layer.

In step S560, sharing of the convolutional layer is kept unchanged, and the CNN detection network continues to be fine-tuned to update the biases and the weight matrix

$$W = W + η ( \frac{1}{{n}_{s}} Δ W ) , a = a + η ( \frac{1}{{n}_{s}} Δ a ) , b = b + η ( \frac{1}{{n}_{s}} Δ b )$$

until they converge, and a final firearm detection network model is created, where nₛ is a number of training samples, a and b are initial biases of the visible layer and the hidden layer, W is an initial weight matrix, Δa, Δb and ΔW are increments of the biases and the weight matrix, and η is a learning rate for updating the network biases and the weights, which has a value in a range between (0,1).

FIG. 6 illustrates a schematic flowchart of a process of detecting a firearm according to an embodiment of the present disclosure. As shown in FIG. 6, the firearm detection process is divided into two steps of image preprocessing and firearm detection. In step S610, X-ray inspection is performed on a luggage using the inspection system illustrated in FIG. 1 to obtain a transmission image. For example, the image may also be pre-processed in this step. The collected firearm image information is pre-processed using the above-mentioned image preprocessing method. For example, in order to be applicable to scanning devices of various small article machines, the images may be normalized while acquiring the images. Specifically, assuming that an original two-dimensional image signal is X, a normalized image X̅ may be obtained by scaling a resolution of X to 5 mm/pixel according to physical parameters of a scanning device and performing grayscale stretching on X.

Then, in step S620, a plurality of candidate regions in the transmission image are determined using the trained firearm detection neural network. For example, the resulting pre-processed firearm image is input into the detection network, which is a subset of networks created using a model, and a plurality of candidate regions are generated in the input image. In general, the obtained plurality of candidate regions which include the same firearm are detected, and have different sizes. In addition, if there are multiple firearms included in the luggage, a plurality of candidate regions may be generated for each of the firearms.

In step S630, the plurality of candidate regions are classified using the firearm detection neural network to determine whether there is a firearm included in the transmission image. For example, firearm classification is performed in the candidate regions using the firearm detection neural network, and if a confidence level for a firearm in a region is greater than a specified threshold, for example, 0.9, it is considered that there is a firearm in this region.

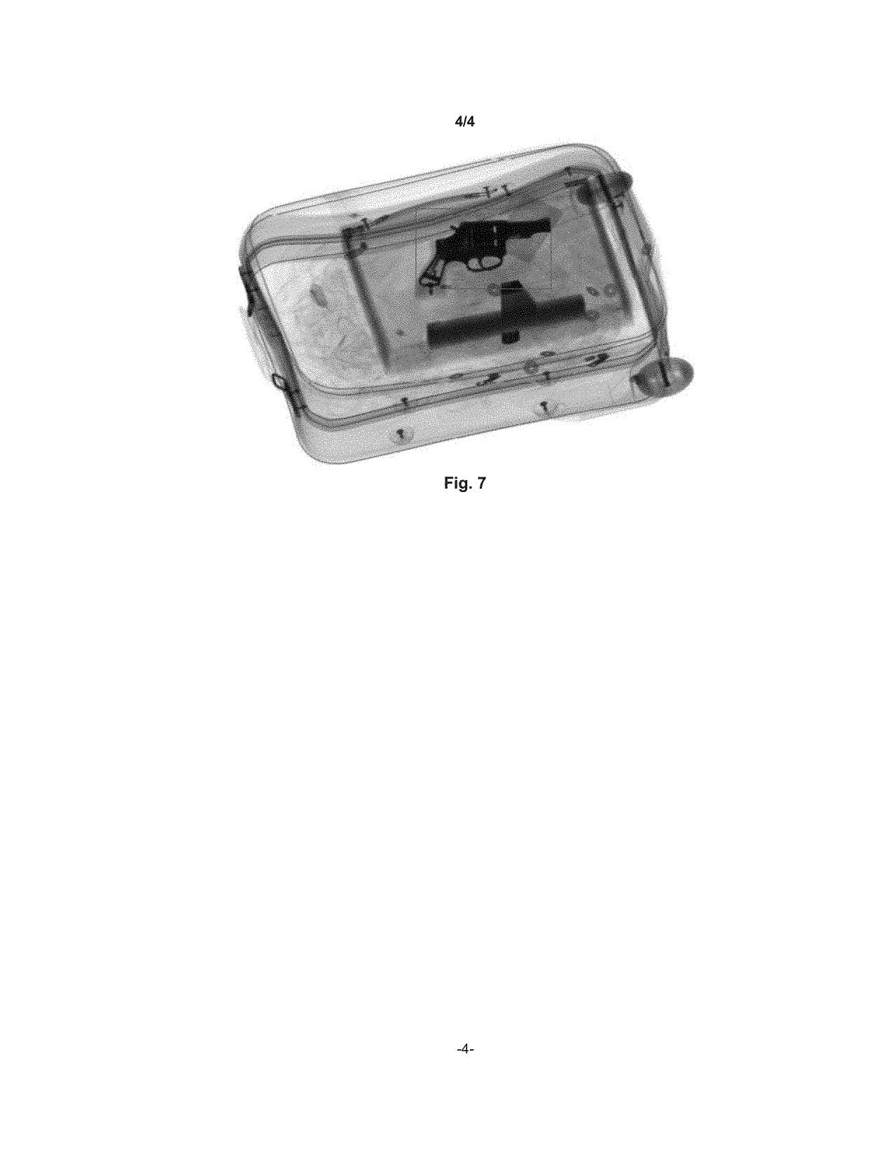

FIG. 7 illustrates a diagram of detecting a firearm in a luggage according to an embodiment of the present disclosure. As shown in FIG. 7, a rectangular block may be marked, and all candidate regions in which there is a firearm may finally be fused to obtain a final position of the firearm.

The automatic firearm detection technology according to the above embodiments can detect a firearm from a scanned image of a small article machine, which can avoid the problems of detection vulnerability and inefficiency of manual image judgment using the traditional methods and is of great significance for cracking down on illegal carrying of firearms.

The foregoing detailed description has set forth various embodiments of the inspection device and the method for detecting a firearm in a luggage via the use of diagrams, flowcharts, and/or examples. In a case that such diagrams, flowcharts, and/or examples contain one or more functions and/or operations, it will be understood by those skilled in the art that each function and/or operation within such diagrams, flowcharts or examples may be implemented, individually and/or collectively, by a wide range of structures, hardware, software, firmware, or virtually any combination thereof. In one embodiment, several portions of the subject matter described in the embodiments of the present disclosure may be implemented via Application Specific Integrated Circuits (ASICs), Field Programmable Gate Arrays (FPGAs), Digital Signal Processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of those skilled in the art in ray of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

While the present disclosure has been described with reference to several typical embodiments, it is apparent to those skilled in the art that the terms are used for illustration and explanation purpose and not for limitation. The present disclosure may be practiced in various forms without departing from the spirit or essence of the present disclosure. It should be understood that the embodiments are not limited to any of the foregoing details, and shall be interpreted broadly within the spirit and scope as defined by the following claims. Therefore, all of modifications and alternatives falling within the scope of the claims or equivalents thereof are to be encompassed by the claims as attached.

I/We claim:

1. An inspection device, comprising:
an X-ray inspection system configured to perform X-ray inspection on a luggage to obtain a transmission image;
a memory having the transmission image stored thereon; and
a processor configured to:
determine a plurality of candidate regions in the transmission image using a trained firearm detection neural network; and
classify the plurality of candidate regions using the firearm detection neural network to determine whether there is a firearm included in the transmission image.

2. The inspection device according to claim 1, wherein the processor is configured to calculate a confidence level of including a firearm in each candidate region, and determine that there is a firearm included in a candidate region in a case that a confidence level for the candidate region is greater than a specific threshold.

3. The inspection device according to claim 1, wherein the processor is configured to mark and fuse images of the firearm in various candidate regions to obtain a position of the firearm in a case that the same firearm is included in a plurality of candidate regions.

4. The inspection device according to claim 1, wherein the memory has sample transmission images of firearms stored thereon, and the processor is configured to train the firearm detection neural network by the following operations:
fusing a Region Proposal Network (RPN) and a conventional layer of a Convolutional Neural Network (CNN) to obtain an initial detection network; and
training the initial detection network using the sample transmission images to obtain the firearm detection neural network.

5. A method for detecting a firearm in a luggage, comprising steps of:
performing X-ray inspection on the luggage to obtain a transmission image;
determining a plurality of candidate regions in the transmission image using a trained firearm detection neural network; and
classifying the plurality of candidate regions using the firearm detection neural network to determine whether there is a firearm included in the transmission image.

6. The method according to claim 5, further comprising steps of:
calculating a confidence level of including a firearm in each candidate region, and determining that there is a firearm included in a candidate region in a case that a confidence level for the candidate region is greater than a specific threshold.

7. The method according to claim 5, further comprising steps of:
in a case that the same firearm is included in a plurality of candidate regions, marking and fusing images of the firearm in various candidate regions to obtain a position of the firearm.

8. The method according to claim 5, wherein the firearm detection neural network is trained by the following operations:
creating sample transmission images of firearms;
fusing a Region Proposal Network (RPN) and a conventional layer of a Convolutional Neural Network (CNN) to obtain an initial detection network; and
training the initial detection network using the sample transmission images to obtain the firearm detection neural network.

9. The method according to claim 8, wherein the step of training the initial detection network comprises:
adjusting the initial detection network using a plurality of sample candidate regions determined from the sample transmission images in a case of not sharing data of the convolutional layer between the RPN and the CNN;
training the RPN in a case of sharing the data of the convolutional layer between the RPN and the CNN; and
adjusting the initial detection network to converge in a case of keeping sharing the data of the convolutional layer between the RPN and the CNN unchanged to obtain the firearm detection neural network.

10. The method according to claim 9, wherein the step of training the initial detection network further comprises:
deleting a sample candidate region in the plurality of sample candidate regions which has an overlapped area less than a threshold with a rectangular block which is manually marked for a firearm.
